(19) United States
(12) Patent Application Publication
(10) Pub. No.: US 2026/0178095 A1
(43) Pub. Date: Jun. 25, 2026

(54) GLOBAL CROSS-TIME ZONE COMPUTING POWER SCHEDULING METHOD

(71) Applicant: Taiwan Intelligence Research and Development CO., LTD., Taipei City (TW)

(72) Inventors: Yun-Cheng Chou, Taipei City (TW); Teng-Ruei Chen, Taipei City (TW); Shun-Yu Chung, Taipei City (TW); Chen-Che Lu, Taipei City (TW); Hsin Lu, Taipei City (TW); Kai-Hung Lin, Taipei City (TW)

(21) Appl. No.: 19/061,998

(22) Filed: Feb. 24, 2025

(30) Foreign Application Priority Data
Dec. 23, 2024 (TW) 113150268

(51) Int. Cl. G06F 1/26; G06F 9/50

(52) U.S. Cl. CPC G06F 1/266; G06F 9/5044

(57) ABSTRACT

To address the issue of more efficient utilization of computing resources across different time zones, this invention provides a global cross-time-zone computing power scheduling method. The computing platform performs the following steps: receive computing power demand information from at least one time zone and store it in a storage module; according to objective function and constraints, use the machine learning module, based on the machine learning algorithm, the heuristic algorithm, or deep learning algorithm module to calculate a computing power scheduling plan that maximizes the profitability and utilization rate of the computing platform; and, allocate GPU resources in at least one time zone according to the computing power scheduling plan.

### CROSS-REFERENCE TO RELATED APPLICATION

This application claims the priority of Taiwanese patent application No. 113150268, filed on Dec. 23, 2024, which is incorporated herewith by reference.

### BACKGROUND OF THE INVENTION

### 1. Field of the Invention

The present invention relates generally to a global cross-time zone computing power scheduling method, which schedules the computing power of GPU resources within a global time zone range and meets the maximum profit rate and utilization rate.

### 2. The Prior Arts

With the rapid growth of global computing demand, the scheduling of computing resources has become a common demand. In the prior arts, the allocation and scheduling of computing resources are usually based on the computing needs of a fixed server cluster and within a single time zone. However, due to the time zone differences among regions, the computing demands in different regions have obvious peak and valley differences in time, which leads to waste of resources and inefficient utilization. For example, some time zones have lower demand for computing power during non-working hours, while other time zones face peak demand at the same time. The use of traditional methods finds it difficult to effectively utilize these differences to optimize the allocation of resources that provide computing power, namely GPU resources.

Currently, the scheduling of GPU resources is mainly concentrated in certain regional areas, and there is a lack of effective cross-time zone coordination mechanism. As a high-performance parallel computing processor, GPU is widely used in fields such as artificial intelligence and data analysis. However, the demand for GPU computing resources is usually concentrated in a specific time period. Therefore, scheduling GPU resources across regions and time zones to meet global demand becomes a major challenge. Existing methods cannot take into account the changes in GPU demand in various regions, resulting in idle GPU resources in some areas and resource shortages in other areas. In addition, due to the lack of a global scheduling method, it is difficult to ensure maximum utilization of GPU resources and a reasonable utilization rate.

The current computing resource scheduling system needs to maximize GPU resource utilization while also meeting high economic profit margins. However, most existing computing power scheduling methods do not fully consider the optimization of profit margins. Scheduling systems usually allocate GPU resources based only on computing needs, while ignoring key factors such as cost control and operational efficiency, resulting in low profit margins. At the same time, due to the lack of GPU resource balancing strategies across time zones, the utilization rate of computing resources such as GPUs is often low.

### SUMMARY OF THE INVENTION

In order to solve the aforementioned problems, the present invention proposes a global cross-time zone computing power scheduling method. By continuously analyzing the trends of historical data and real-time data, future GPU resource requirements can be predicted, thereby adjusting GPU resource allocation in advance. As such, not only the scheduling accuracy is improved, but also the efficient use and economy of resources are ensured to meet the diverse needs of users.

The present invention receives computing power demand information from multiple time zones and combines with a machine learning module based on one of the heuristic algorithms, machine learning algorithms, or deep learning algorithms to generate a computing power scheduling solution that can dynamically calculate the maximum profit margin and utilization yield. This dynamic scheduling mechanism can make full use of the differences in computing power requirements in various time zones and overcome the traditional method's reliance on fixed time periods to achieve optimal allocation of resources, and thus improve the efficiency of the overall computing power platform.

In the heuristic algorithms, machine learning algorithms, or deep learning algorithms model, the heuristic algorithm can be at least one of Genetic Algorithm (GA), Simulated Annealing Algorithm (SAA), Ant Colony Optimization (ACO), Bee Algorithm (BA), Particle Swarm Optimization (PSO), Memetic Algorithm (MA), Cultural Algorithms (CA), Differential Evolution (DE), Bat Algorithm (BA), Artificial Fish-Swarm Algorithm (AFSA), Harmony Search Algorithm (HSA), and Water Flow Algorithm (WFA). The machine learning algorithm may be at least one of the following: Linear Regression, Polynomial Regression, Logistic Regression, Artificial Neural Network, Network (ANN), K-nearest neighbor classification (KNN), Decision Tree, Random Forest, Support Vector Machine (SVM), Adaptive Boosting (AdaBoost), Extreme Gradient Boosting (XGBoost), Discrete-time Markov Chain (DTMC), and Monte Carlo method. In addition, the deep learning algorithm can be at least one of Deep Belief Network (DBN), Convolutional neural network (CNN), and Recurrent Neural Network (RNN). Alternatively, the deep learning algorithm can be other deep learning algorithms extended based on the underlying architecture of the above three neural networks.

The heuristic algorithms, machine learning algorithms, or deep learning algorithms listed above are for example only. Other types of heuristic algorithms, machine learning algorithms, or deep learning algorithms may also be used, and the principles are the similar.

In addition, comprehensive optimization is performed on the target-based and constraint-based settings, overcoming the defects of previous technologies that do not take profit margins and utilization rates into account. By clarifying the target variables, such as total profit and GPU utilization rate, and computing constraints, such as profit margin and scheduling constraints, the scheduling plan is made more scientific and reasonable. Moreover, this method allows the allocation of GPU resources to be dynamically adjusted under a variety of electricity pricings and GPU resource usage conditions, thereby maximizing the utilization efficiency and economic benefits of GPU resources and adapting to dynamic market demands.

The present invention provides a global cross-time zone computing power scheduling method, executed by a computing power platform, comprising: step 1, receiving computing power demand information from at least one time zone and storing the demand information in a storage module; step 2, according to objective function and constraints, using a machine learning module based on a heuristic algorithms, machine learning algorithms, or deep learning algorithms, to calculate a computing power scheduling plan that maximizing a profit rate and an utilization rate of the computing power platform; and step 3, allocating GPU resources in at least one time zone according to the computing power scheduling plan.

According to an embodiment of the present invention, the objective function and constraints comprise: model parameters, which further comprise: target variables, decision variables, parameters, and response variables.

According to an embodiment of the present invention, the target variables include: total profit and GPU utilization rate within a specified period of time.

According to an embodiment of the present invention, the constraints can calculate profit rate, utilization rate, and scheduling constraint.

According to one embodiment of the present invention, the machine learning module based on one of the heuristic algorithms, machine learning algorithms, or deep learning algorithms dynamically adjusts the computing power scheduling plan according to the real-time computing power demand information, the available GPU resources, and the electricity price.

According to one embodiment of the present invention, the machine learning module based on one of the heuristic algorithms, machine learning algorithms, or deep learning algorithms predicts future GPU resource requirements by analyzing trends of historical data and real-time data and adjusts GPU resource allocation in advance.

According to an embodiment of the present invention, the real-time data comprises: electricity prices in any combination of different time zones, different time periods, GPU resources in use, and idling GPU resources.

According to one embodiment of the present invention, the machine learning module based on one of the heuristic algorithms, machine learning algorithms, or deep learning algorithms extracts and summarizes a behavior pattern of a user or a system according to the historical data to adjust the GPU resource allocation in advance.

According to an embodiment of the present invention, the objective function is: max=(α·TP+β·UR), where α and β are weight coefficients.

According to an embodiment of the present invention, the constraints include:

$$\begin{matrix}UR = {\sum }_{i = 1}^{n} {\sum }_{t = 1}^{24} {A}_{i , t} / {\sum }_{i = 1}^{n} {G}_{i} \times 24 ; \\ {\sum }_{j \neq i} {X}_{i , j , t} \leq {G}_{i} , {\sum }_{j \neq i} {X}_{i , j , t} \leq {D}_{i , t} , {X}_{i , j , t} \geq 0 , {G}_{i} \geq 0 , {D}_{i , t} \geq 0 ;\end{matrix}$$

$$TP = {\sum }_{i = 1}^{n} {\sum }_{t = 1}^{24} ( {P}_{i , t} \times {A}_{i , t} ) - {\sum }_{i = 1}^{n} {\sum }_{t = 1}^{24} ( {E}_{i , t}^{active} \times {A}_{i , t} + {E}_{i , t}^{idle} \times {I}_{i , t} + {C}_{i , t}^{deprec} \times {G}_{i} ) ,$$

$${A}_{i , t} = min ( {D}_{i , t} \times {G}_{i} + {\sum }_{k \neq i} {X}_{k , i , t} - {\sum }_{l \neq i} {X}_{i , l , t} ) , {I}_{i , t} = {G}_{i} - {A}_{i , t}$$

The global cross-time zone computing power scheduling method of the present invention has significant advantages. First, by integrating the computing power demand information of multiple time zones, the method can respond to the computing demand fluctuations of various regions in real time, thereby maximizing the utilization efficiency of GPU resources. Second, relying on the advanced machine learning module technology based on one of the heuristic algorithms, machine learning algorithms, or deep learning algorithms, the method can dynamically adjust the allocation of GPU resources based on the analysis of historical data and real-time data to predict future GPU resource requirements to make scheduling more intelligent. Moreover, the method of the present invention performs well in optimizing profit margins and utilization rates. Through the use of objective function and constraints, the present invention ensures the economic benefits and operational efficiency of the computing platform, and achieves efficient and sustainable use of computing resources. These advantages enable the present invention to benefit from broad application prospects in the field of global computing resource scheduling.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a system schematic diagram of a global cross-time zone computing power scheduling method according to an embodiment of the present invention;

FIG. 2 is a system diagram of a global cross-time zone computing power scheduling method according to an embodiment of the present invention;

FIG. 3 is a schematic diagram of a global cross-time zone computing power scheduling method according to an embodiment of the present invention;

FIG. 4 is a schematic diagram of a formula for using a global cross-time zone computing power scheduling method according to an embodiment of the present invention;

FIG. 5 is a schematic diagram of a formula for using a global cross-time zone computing power scheduling method according to an embodiment of the present invention;

FIG. 6 is a schematic diagram of computing power information of a global cross-time zone computing power scheduling method according to an embodiment of the present invention;

FIG. 7 is a schematic diagram of computing power information of a global cross-time zone computing power scheduling method according to an embodiment of the present invention;

FIG. 8 is a performance statistics diagram of a global cross-time zone computing power scheduling method according to an embodiment of the present invention;

FIG. 9 is a schematic diagram of computing conditions for a global cross-time zone computing power scheduling method according to an embodiment of the present invention.

### DETAILED DESCRIPTION OF THE PREFERRED EMBODIMENT

The inventive concept will be explained more fully hereinafter with reference to the accompanying drawings in which exemplary embodiments of the inventive concept are shown. Advantages and features of the inventive concept and methods for achieving the same will be apparent from the following exemplary embodiments, which are set forth in more details with reference to the accompanying drawings. However, it should be noted that the present inventive concept is not limited to the following exemplary embodiments, but may be implemented in various forms. Accordingly, the exemplary embodiments are provided merely to disclose the inventive concept and to familiarize those skilled in the art with the type of the inventive concept. In the drawings, exemplary embodiments of the inventive concepts are not limited to the specific examples provided herein and are exaggerated for clarity.

The terminology used herein is used to describe particular embodiments only, and is not intended to limit the present invention. As used herein, the singular terms “a” and “the” are intended to include the plural forms as well, unless the context clearly dictates otherwise. As used herein, the term “and/or” includes any and all combinations of one or more of the associated listed items. It will be further understood that “include” and “comprising” when used in this specification specify the presence of the features, integers, operations, elements and/or components, but do not exclude the presence or addition of one or more other features, integers, operations, elements, components and/or parts thereof.

In the context of global computing needs, the existing computing power scheduling methods cannot effectively cope with fluctuations in computing power demand in different regions and time zones. Traditional methods are often based on static models and cannot adapt to rapidly changing market conditions in real time, resulting in waste or insufficient computing resources. For example, in some time zones, computing power demand may far exceed available resources during peak periods, while in other time zones there may be idle resources. The lack of a dynamic scheduling mechanism means that resources cannot be optimally allocated, thus affecting overall operational efficiency and economic benefits.

Researching the prior art shows that many computing power scheduling schemes failed to fully consider the balance between profit margin and utilization rate. Existing scheduling systems usually focus on meeting basic computing power requirements while neglecting the pursuit of maximizing economic benefits. This results in the computing power platform being unable to achieve optimal resource allocation during operation, thus affecting the company's profitability. Therefore, how to improve profit margin while ensuring high utilization rate has become a technical problem needs to be addressed urgently.

In order to solve this problem, it is also discovered that relying solely on traditional computing power scheduling methods cannot effectively meet the complex needs across time zones. Using only static resource allocation strategies is not only difficult to respond to computing power fluctuations in various regions in real time, but may also lead to inefficient use of resources. Therefore, the inventors realize that introducing a dynamic scheduling mechanism is the key to solving this problem. In addition, historical data analysis alone cannot predict future changes in demand; real-time data and market trends must be combined to make intelligent decisions.

Based on the above background, the present invention provides a global cross-time zone computing power scheduling method. The scheduling method uses a machine learning module based on one of the heuristic algorithms, machine learning algorithms, or deep learning algorithms to dynamically optimize the allocation of computing resources. This method monitors the computing power demand and electricity prices in different time zones in real time and adjusts the resource allocation plan in a timely manner, which not only improves the utilization rate but also maximizes profits. This innovative approcah provides an effective way to solve the technical bottlenecks in traditional scheduling methods, making the scheduling of computing resources more intelligent and flexible.

The accompanying drawings are included to provide a further understanding of the invention, and are incorporated in and constitute a part of this specification. The drawings illustrate embodiments of the invention and, together with the description, serve to explain the principles of the invention.

In the following description, many specific details are set forth to facilitate a full understanding of the present invention. However, the present invention may also be implemented in other ways different from those described herein. A person skilled in the art may modify the present invention without departing from the scope of the present invention. Similar extensions are made within the scope of the invention, so the present invention is not limited by the specific embodiments disclosed below.

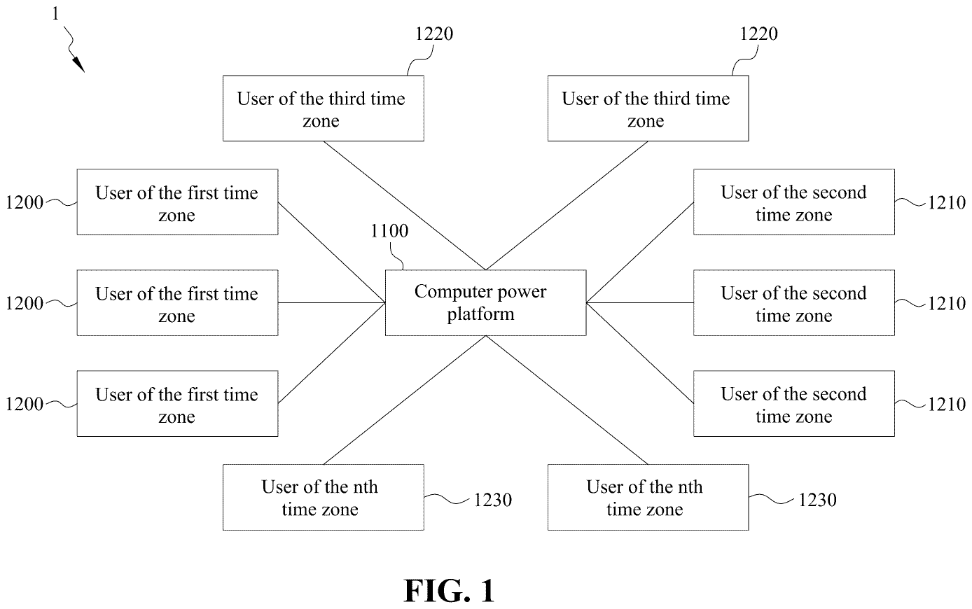

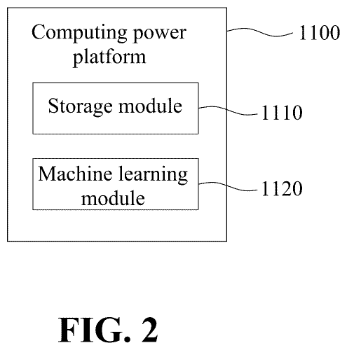

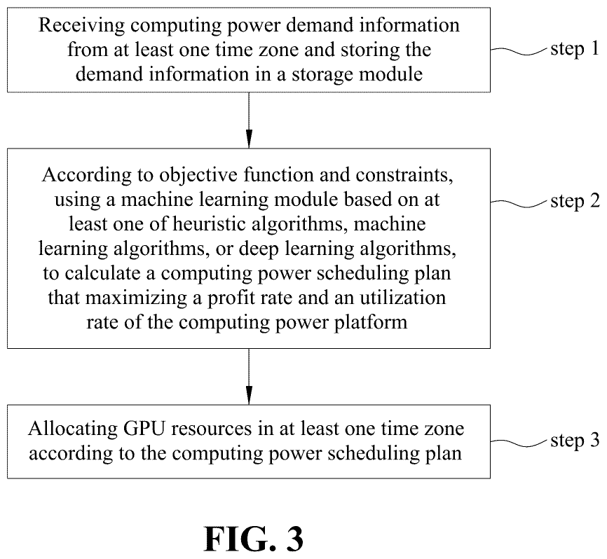

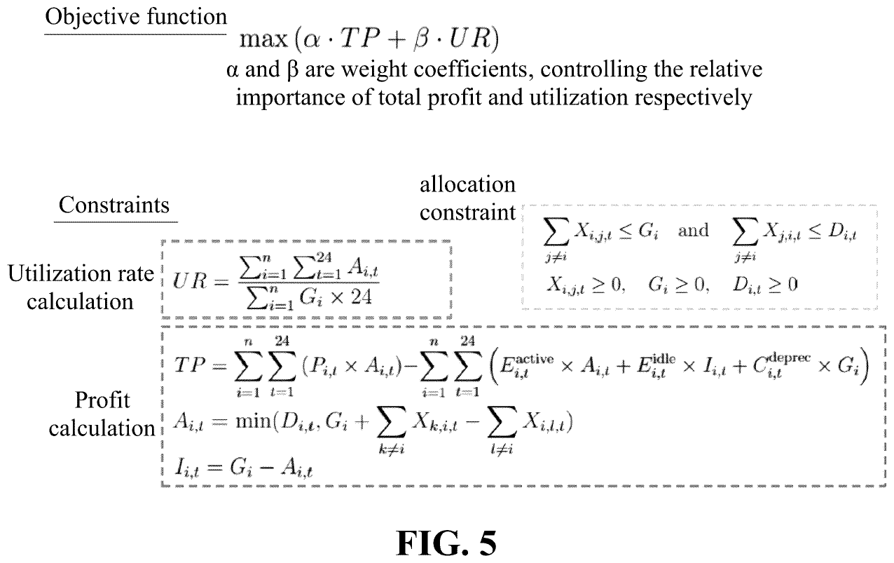

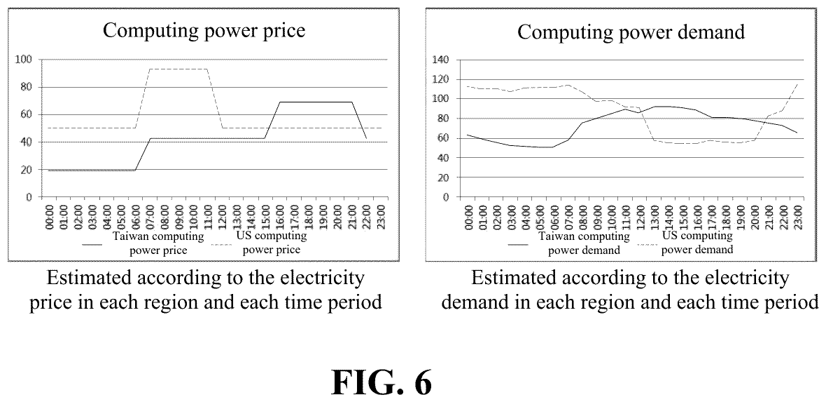

FIG. 1 and FIG. 2 are schematic diagrams of a computing power platform system 1 of a global cross-time zone computing power scheduling method according to an embodiment of the present invention. As shown in FIG. 1, users in at least one time zone around the world, such as a first time zone user 1200, a second time zone user 1210, a third time zone user 1220, an nth time zone user 1230, etc., can submit computing power requirements through a computing power platform 1100. The computing power scheduling solution suitable for various conditions is calculated by the computing power platform 1100. As shown in FIGS. 3 and 5, a global cross-time zone computing power scheduling method of the present invention is applicable to the computing power platform 1100, which performs the following steps: Step 1, receiving computing power demand information of at least one time zone, and storing the computing power demand information in a storage module; Step 2, according to objective function and constraints, a machine learning module 1120 based on one of a heuristic algorithms, machine learning algorithms, or deep learning algorithms calculating a computing power scheduling plan that maximizing profit margin and utilization rate of the computing power platform 1100; Step 3, allocating GPU resources in at least one time zone according to the computing power scheduling plan. By receiving computing power demand information in different time zones and using the machine learning module 1120 based on one of the heuristic algorithms, machine learning algorithms, or deep learning algorithms to calculate the optimal computing power scheduling solution, the method can effectively integrate computing resources across time zones around the world. By reasonably allocating GPU resources, the present invention reduces the phenomenon of GPU resource idleness, greatly improves the utilization rate of the computing power platform 1100, and thus maximizes the utilization of GPU resources. The present invention calculates the maximum profit based on the objective function and the constraints. A high-efficiency computing power scheduling solution ensures that while computing power requirements are met, operating costs are optimized from the perspective of the computing power platform. As shown in FIG. 6, the method intelligently analyzes factors such as computing power price and computing power demand, and reasonably arranges resource calls in each time zone, thereby effectively controlling operating costs and improving the overall profit margin of the computing power platform 1100. The scheduling method of the present invention is capable of monitoring the demand changes in each time zone in real time, and analyzing the historical data and the real-time data through the machine learning module 1120 based on one of the heuristic algorithms, machine learning algorithms, or deep learning algorithms to realize the accurate prediction of future demand. By dynamically adjusting resource allocation, the present invention can quickly respond to fluctuations in computing power demand, allowing the computing power platform 1100 to operate more flexibly and efficiently on a global scale.

In a global cross-time zone computing power scheduling method according to an embodiment of the present invention, the objective function and the constraints include: model parameters, further including: target variables, decision variables, parameters, and response variables. This method achieves balanced optimization of multiple performance indicators by setting target variables (such as profit margin and utilization rate), where the objective function is: max=(α·TP+β·UR), where α and β are weight coefficients, respectively controlling the relative importance of total profit and utilization rate, maximizing profit and GPU utilization rate while meeting the user's computing power requirements. The constraints include:

$$\begin{matrix}UR = {\sum }_{i = 1}^{n} {\sum }_{t = 1}^{24} {A}_{i , t} / {\sum }_{i = 1}^{n} {G}_{i} \times 24 ; \\ {\sum }_{j \neq i} {X}_{i , j , t} \leq {G}_{i} , {\sum }_{j \neq i} {X}_{i , j , t} \leq {D}_{i , t} , {X}_{i , j , t} \geq 0 , {G}_{i} \geq 0 , {D}_{i , t} \geq 0 ;\end{matrix}$$

$$TP = {\sum }_{i = 1}^{n} {\sum }_{t = 1}^{24} ( {P}_{i , t} \times {A}_{i , t} ) - {\sum }_{i = 1}^{n} {\sum }_{t = 1}^{24} ( {E}_{i , t}^{active} \times {A}_{i , t} + {E}_{i , t}^{idle} \times {I}_{i , t} + {C}_{i , t}^{deprec} \times {G}_{i} ) ,$$

$${A}_{i , t} = min ( {D}_{i , t} \times {G}_{i} + {\sum }_{k \neq i} {X}_{k , i , t} - {\sum }_{l \neq i} {X}_{i , l , t} ) , {I}_{i , t} = {G}_{i} - {A}_{i , t}$$

The target variable is TP: total profit in the global time zone period [1,24]; UR: GPU utilization rate in the global time zone period [1,24]; the decision variable is P_{i,t}: the GPU rental price for each time period in each region; the number of GPUs available for scheduling in each region Gᵢ, where i represents the region; the parameter

$${E}_{i , t}^{active} :$$

the power demand of each region in each time period; D_{i,t}: the computing power demand of each region in each period; X^{i,j,t}=X_{j,i,t}: the number of GPUs used by scheduling from region Rᵢ to Rⱼ at time t; I_{i,t}: the number of idle GPUs in each region in each time period; A_{i,t}: the number of GPUs used in each region in each time period; the response variables are: R₁, R₂, . . . , Rₙ, the world is divided into n regions; T₁, T₂, . . . , T₂₄ are: time periods of each hour of the day; E_{i,t}: the electricity price of each time period in each time zone;

$${E}_{i , t}^{idle} :$$

the power cost of the GPU in each region during each period when the GPU is idle;

$${E}_{i , t}^{active} :$$

the power cost of the GPU in each region during each period when the GPU is in use.

As such, the computing power platform system 1 can not only meet the computing power demand, but also achieve profit maximization and efficient resource utilization, which greatly reduces the operating cost of the overall computing power platform 1100 and achieves a dual improvement in economic benefits and efficiency. The introduction of decision variables allows the computing power platform system 1 to flexibly adjust the computing power scheduling plan. By optimizing decision variables, the computing platform 1100 can adapt to changes in demand in different time zones in real time, and quickly adjust resource allocation when external conditions such as electricity prices and resource supply fluctuate, thus significantly enhancing the flexibility and responsiveness of the computing platform system 1. The response variables allows the computing power platform system 1 to monitor and calibrate the scheduling plan in real time through a feedback mechanism, thereby achieving closed-loop optimization. The computing power platform system 1 can automatically analyze the execution effect of the current scheduling plan and make self-adjustments based on the operating data. This feedback mechanism ensures that the computing power platform 1100 is always in the optimal state in a dynamic environment, effectively improving the utilization rate of computing power resources and the overall stability of the computing power platform 1100.

In a global cross-time zone computing power scheduling method according to an embodiment of the present invention, the target variables include: total profit and GPU utilization rate within a specified time period. By setting “total profit within a specified period of time” as the key target variable, the computing power platform system 1 can dynamically adjust the scheduling plan of computing power resources according to the demand and electricity prices in each time zone, and optimize the balance between cost and benefit. Therefore, the computing platform 1100 can seize opportunities with high demand and high returns in different time periods, effectively improve the profitability of the computing platform 1100, and maximize profits. By setting the “GPU utilization rate” as the target variable, the present invention ensures efficient use of computing resources on a global scale. The computing power platform 1100 will prioritize allocating idle GPU resources to areas in need, reducing resource idleness and waste. By improving the GPU utilization rate, the computing power platform system 1 can significantly increase the overall computing power output and service capabilities of the computing power platform 1100, thus improving operational efficiency and maximize resource utilization.

In a global cross-time zone computing power scheduling method according to an embodiment of the present invention, the constraint formula can calculate the profit rate, utilization rate, and scheduling restriction. The profit margin restriction ensures that the computing power platform system 1 takes both economic benefits and operating costs into consideration when scheduling computing power resources. By setting profit margin calculation restrictions, the computing power platform system 1 can control operating costs and achieve high returns while meeting computing power requirements. This not only increases the overall profitability of the computing platform 1100, but also enables the platform to maintain its cost advantage in the fierce market competition. The utilization rate restriction ensures the efficient use of resources such as GPUs and avoids idleness and wasted resources. By the utilization rate restriction, the computing platform system 1 prioritizes the dispatch of available resources to the regions or time zones with the greatest demand, thereby improving the resource utilization of the computing platform 1100 on a global scale and making the overall operation more efficient. When formulating resource allocation plans, the computing power platform system 1 can make reasonable constraints based on current resource supply, demand, and external conditions to avoid unreasonable overload scheduling or resource mismatch. Scheduling restrictions help the computing power platform system 1 to allocate resources more scientifically between different time zones and time periods, effectively ensuring the feasibility and stability of the scheduling plan, while ensuring the efficient and stable operation of the computing power platform 1100.

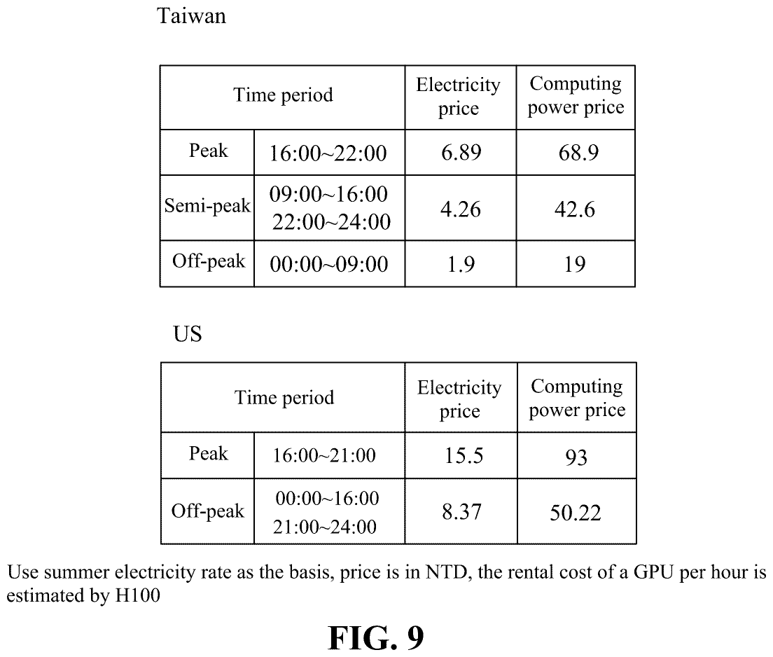

In an embodiment of the global cross-time zone computing power scheduling method of the present invention, the machine learning module 1120 based on one of the heuristic algorithms, the machine learning algorithms, or the deep learning algorithms, calculates the computing power demand information according to the real-time changes, available GPU resources, and electricity prices to dynamically adjust the computing power scheduling plan. By analyzing the computing power requirements of different regions in real time, the machine learning module 1120 based on one of the heuristic algorithms, machine learning algorithms, or deep learning algorithms can intelligently prioritize 1 allocation during high-demand periods to ensure full utilization of the computing power resources. Real-time monitoring and analysis of demand fluctuations enables the computing power platform system 1 to more accurately respond to changes in computing power demand in different regions, thereby improving the efficiency of overall resource allocation. As shown in FIG. 9, combined with real-time changes in electricity prices, the computing power platform system 1 can increase the use of GPU resources during periods of low electricity costs and reasonably reduce power consumption during peak electricity price periods. This strategy significantly optimizes electricity consumption, reduces operating costs, and improves the overall profit margin of computing platform 1100, making computing platform 1100 more economically adaptable. Dynamically adjusting the computing power scheduling plan gives the computing platform system 1 high flexibility and adaptability. The machine learning module 1120 based on one of the heuristic algorithms, machine learning algorithms, or deep learning algorithms can continuously analyze real-time data and historical data to automatically adapt to environmental and market changes. This flexibility not only improves the response speed of computing power scheduling, but also effectively responds to sudden fluctuations in computing power demand, ensuring that the computing power platform 1100 is always in the optimal operating state.

As shown in FIG. 2, a global cross-time zone computing power scheduling method according to an embodiment of the present invention uses a machine learning module 1120 based on one of the heuristic algorithms, machine learning algorithms, or deep learning algorithms that analyzes historical data and real-time data trends to predict future resource requirements and adjust GPU resource allocation in advance. The machine learning module 1120, which is based on one of the heuristic algorithms, machine learning algorithms, or deep learning algorithms, can accurately predict the changes in computing power demand in different time periods and regions based on the comprehensive analysis of historical data and real-time data. By understanding future resource requirements in advance, the computing power platform system 1 can better plan computing power allocation and reduce scheduling delays caused by sudden demands. This accurate demand forecasting improves the computing platform 1100's ability to control future demand and ensures a stable supply of computing platform 1100 resources. After predicting future demand trends, the computing platform system 1 can formulate a scheduling plan to optimize allocation of resources in advance. This advance adjustment mechanism ensures that the computing platform 1100 can run smoothly during high-demand periods to avoid resource shortages, while reducing unnecessary power consumption during low-demand periods and improving overall resource utilization efficiency. The computing power platform system 1 can proactively optimize scheduling strategies before demand surges or decreases. This not only ensures the stability of the computing platform system 1, but also brings greater adaptability to the computing platform 1100, allowing the system to maintain efficient and economical resource allocation in the face of demand fluctuations, greatly improving the computing platform 1100's responsiveness and scheduling flexibility.

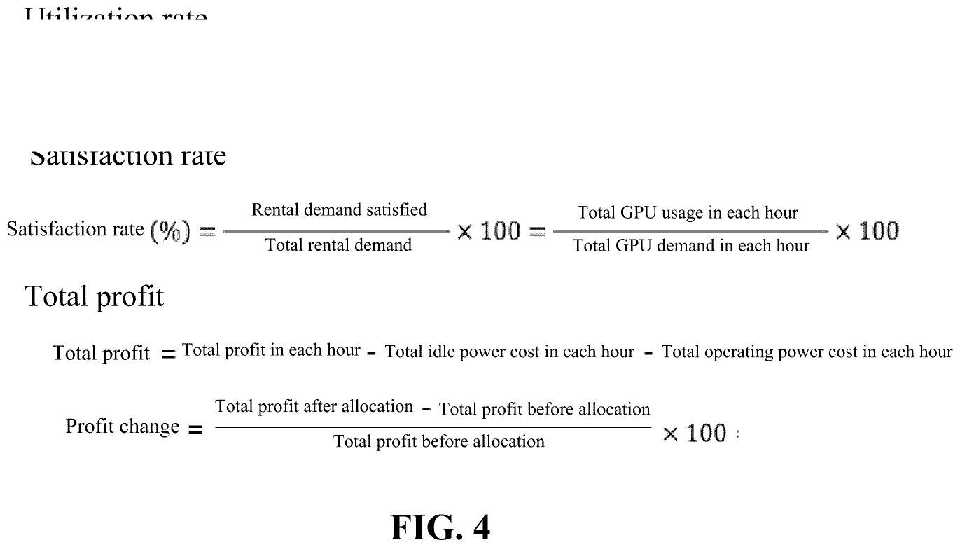

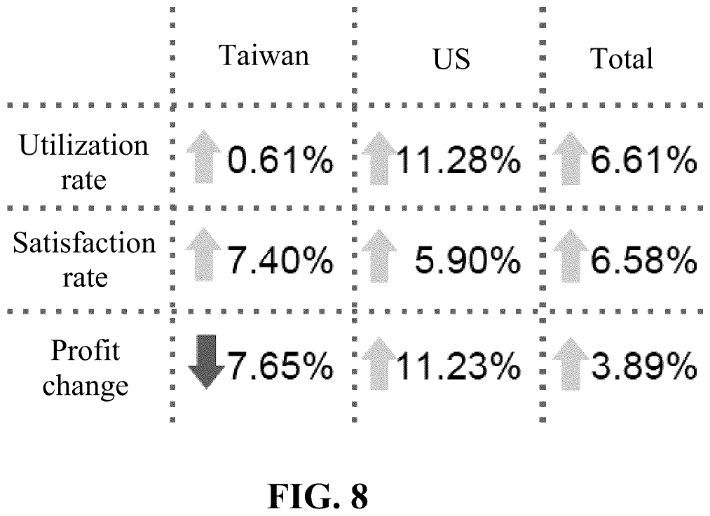

In a global cross-time zone computing power scheduling method according to an embodiment of the present invention, the real-time data includes: electricity prices in any combination of different time zones, different time periods, GPU resources in use, and GPU resources idle. By real-time monitoring of electricity price fluctuations in different time zones, time periods, and GPU usage conditions, the computing power platform system 1 can intelligently select low-price periods for resource allocation, thereby optimizing electricity costs. In particular, idle GPU resources can be preferentially selected for use during periods of low electricity prices, improving economic efficiency and enabling the computing platform 1100 to maintain a cost advantage in global operations. By identifying the use and idle status of GPU resources in combination with electricity prices, the computing power platform system 1 can optimize the allocation priority of GPU resources. During periods of high demand and high electricity prices, the computing platform system 1 will give priority to using the GPU resources that are most suitable for the current load. During periods of low demand or low electricity prices, the computing platform system 1 can dispatch some idle resources to high-demand areas to ensure efficient use of resources on a global scale. By utilizing the combination of electricity prices and computing power demand in different time zones and time periods, the computing power platform system 1 can flexibly adjust the global scheduling strategy of computing power resources. The computing power platform system 1 automatically adapts to electricity market fluctuations in various regions, allocates computing power resources on demand, and reduces electricity expenditure while ensuring resource supply. This cross-time zone intelligent scheduling method has significantly improved the global operational efficiency and competitiveness of the computing platform 1100. As shown in FIG. 8, although the profit margins in some regions have declined, such as in Taiwan, the overall utilization rate has increased by 6.61%, (GPU rental demand) satisfaction rate is 6.58%, and profit change is 3.89%. The calculation formula is as shown in FIG. 4.

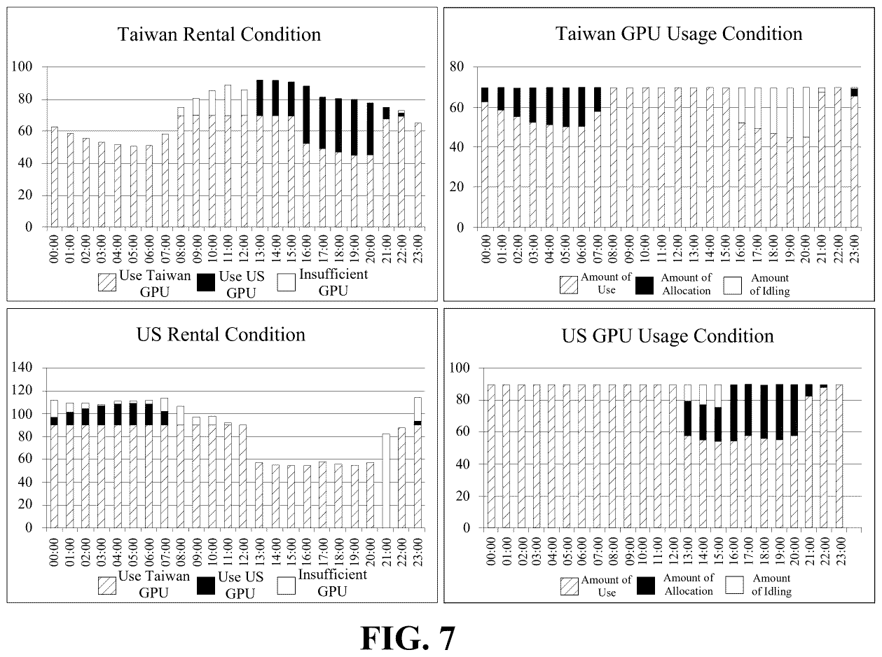

In an embodiment of the global cross-time zone computing power scheduling method of the present invention, one of the modules 1120 of the heuristic algorithm, machine learning algorithm, or deep learning algorithm can extract and summarize the behavior patterns of users or computing power platform system 1 based on historical data, thereby adjusting GPU resource allocation in advance. By analyzing the behavior patterns of users and the computing power platform system 1, the machine learning module 1120 based on one of the heuristic algorithms, machine learning algorithms, or deep learning algorithms can predict the peaks and troughs of computing power demand of specific users. For example, the machine learning module 1120 based on one of the heuristic algorithms, machine learning algorithms, or deep learning algorithms can identify the usage preferences of certain users during a specific period of time or under specific conditions. Based on these behavior patterns, the computing platform system 1 can prepare resources for high-demand periods in advance, avoid insufficient or over-allocation of GPU resources, and ensure the stability and reliability of resource supply. The behavior patterns summarized by the machine learning module 1120 based on heuristic algorithms, machine learning algorithms or, one of the deep learning algorithms allow the computing power platform system 1 to perform personalized computing power resource allocation based on the demand characteristics of different users. The computing power platform system 1 can dynamically adjust the GPU allocation plan to respond to the usage frequency and usage of different users, thereby achieving more efficient and customized resource management. The number of GPUs used, dispatched, and idle in different time zones rented by users in different time zones are shown in FIG. 7. This adaptive resource allocation method reduces resource waste and improves the computing platform 1100's response to user needs. Knowing the overall operation mode and trend of the computing platform system 1 in advance, the machine learning module 1120 based on one of the heuristic algorithms, machine learning algorithms, or deep learning algorithms can effectively avoid potential computing resources conflicts and GPU resource scheduling efficiency is improved. At the same time, by configuring and allocating GPU resources in advance, the computing power platform system 1 can reduce the instability caused by sudden GPU resource requests, so that the computing power platform 1100 can still maintain a stable operation state in a multi-user, multi-time zone environment. The overall scheduling efficiency and reliability of computing platform 1100 are enhanced.

In summary, the present invention provides a global cross-time zone computing power scheduling method, which uses the machine learning module 1120 based on one of the heuristic algorithms, machine learning algorithms, or deep learning algorithms to analyze and extract the behavioral patterns in the historical data, can achieve adaptive adjustments to different demand characteristics, effectively improving the accuracy and scheduling efficiency of GPU resource allocation. The computing power platform system 1 combines real-time data with historical data to predict the future dynamics of GPU resource demand in advance and actively adjusts the configuration strategy of GPU resources, which not only improves the utilization efficiency of computing power resources, but also enhances the stability and response speed of the computing power platform system 1. Ultimately, the present invention can maintain efficient operation in a global environment with multiple users and time zones, effectively controlling costs and improving overall benefits.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A global cross-time zone computing power scheduling method, executed by a computing power platform, comprising:
step 1, receiving computing power demand information from at least one time zone and storing the demand information in a storage module;
step 2, according to objective function and constraints, using a machine learning module based on at least one of heuristic algorithms, machine learning algorithms, or deep learning algorithms, to calculate a computing power scheduling plan that maximizing a profit rate and an utilization rate of the computing power platform; and
step 3, allocating GPU resources in at least one time zone according to the computing power scheduling plan.

2. The global cross-time zone computing power scheduling method according to claim 1, wherein the objective function and constraints comprise: model parameters, which further comprise: target variables, decision variables, parameters, and response variables.

3. The global cross-time zone computing power scheduling method according to claim 2, wherein the target variables include: total profit and GPU utilization rate within a specified period of time.

4. The global cross-time zone computing power scheduling method according to claim 1, wherein the constraints can calculate profit rate, utilization rate, and scheduling constraint.

5. The global cross-time zone computing power scheduling method according to claim 1, wherein the machine learning module based on one of the heuristic algorithms, machine learning algorithms, or deep learning algorithms dynamically adjusts the computing power scheduling plan according to the real-time computing power demand information, the available GPU resources, and the electricity price.

6. The global cross-time zone computing power scheduling method according to claim 1, wherein the machine learning module based on one of the heuristic algorithms, machine learning algorithms, or deep learning algorithms predicts future GPU resource requirements by analyzing trends of historical data and real-time data and adjusts GPU resource allocation in advance.

7. The global cross-time zone computing power scheduling method according to claim 6, wherein the real-time data comprises: electricity prices in any combination of different time zones, different time periods, GPU resources in use, and idling GPU resources.

8. The global cross-time zone computing power scheduling method according to claim 6, wherein the machine learning module based on one of the heuristic algorithms, machine learning algorithms, or deep learning algorithms extracts and summarizes a behavior pattern of a user or a system according to the historical data to adjust the GPU resource allocation in advance.

9. The global cross-time zone computing power scheduling method according to claim 1, wherein the objective function is: max=(α·TP+β·UR), where α and β are weight coefficients.

10. The global cross-time zone computing power scheduling method according to claim 1, wherein the constraints include:
$$\begin{matrix}UR = {\sum }_{i = 1}^{n} {\sum }_{t = 1}^{24} {A}_{i , t} / {\sum }_{i = 1}^{n} {G}_{i} \times 24 ; \\ {\sum }_{j \neq i} {X}_{i , j , t} \leq {G}_{i} , {\sum }_{j \neq i} {X}_{i , j , t} \leq {D}_{i , t} , {X}_{i , j , t} \geq 0 , {G}_{i} \geq 0 , {D}_{i , t} \geq 0 ;\end{matrix}$$
$$TP = {\sum }_{i = 1}^{n} {\sum }_{t = 1}^{24} ( {P}_{i , t} \times {A}_{i , t} ) - {\sum }_{i = 1}^{n} {\sum }_{t = 1}^{24} ( {E}_{i , t}^{active} \times {A}_{i , t} + {E}_{i , t}^{idle} \times {I}_{i , t} + {C}_{i , t}^{deprec} \times {G}_{i} ) ,$$
$${A}_{i , t} = min ( {D}_{i , t} \times {G}_{i} + {\sum }_{k \neq i} {X}_{k , i , t} - {\sum }_{l \neq i} {X}_{i , l , t} ) , {I}_{i , t} = {G}_{i} - {A}_{i , t} .$$
